(19) United States
(12) Patent Application Publication
(10) Pub. No.: US 2021/0259165 A1
(43) Pub. Date: Aug. 26, 2021

(54) CLOTHING AND FASHION ACCESSORIES FOR PLANTS

(71) Applicants: Lillian C. Rauch, Lake Barrington, IL (US); Melanie I. Rauch, Lake Barrington, IL (US)

(72) Inventors: Lillian C. Rauch, Lake Barrington, IL (US); Melanie I. Rauch, Lake Barrington, IL (US)

(21) Appl. No.: 17/183,308

(22) Filed: Feb. 23, 2021

Related U.S. Application Data
(60) Provisional application No. 62/981,021, filed on Feb. 24, 2020.

(51) Int. Cl. A01G 13/02

(52) U.S. Cl. CPC A01G 13/02

(57) ABSTRACT

An article of clothing for a plant and/or a planter, includes a garment configured to be fitted about the plant and/or the planter, with an opening that extends along a length of the garment between a first longitudinal edge and a second longitudinal edge of the garment. Similarly, an ornamental adornment for a plant and/or a planter includes a fashion accessory and one or more supports for affixing the fashion accessory to the plant and/or the planter.

### FIELD OF THE INVENTION

The invention relates to clothing and fashion accessories adapted for wear by plants and planters.

### BACKGROUND OF THE INVENTION

Plants are living things. Houseplants add an element of beauty to the décor in many homes and offices. Just as pets are often treated as full-fledged members of a family, so too are many houseplants. People feed their houseplants, talk to their houseplants, and give their houseplants names. Some people even use the services of a plant hotel to care for their plants when the owners are on vacation.

As the popularity of houseplants continues to grow, the houseplant industry is creating off-shoots, with a variety of online plant delivery services and in-home or in-office plant care. As people invest more time and energy in their houseplants, there is a need or desire to find ways to personalize, and perhaps to personify, houseplants.

### SUMMARY OF THE INVENTION

The object of the invention, therefore, is to provide clothing and accessories configured to be worn by plants and/or planters. Unlike clothing for human beings, the clothing is specially configured to either fit around a portion of a plant, or around at least a portion of a planter in which the plant is situated. Certain outfits may include clothing that adorns both the plant and the planter.

According to certain embodiments, an article of clothing for a plant may include a garment to be worn by the plant, with the garment including an opening that extends at least a partial length of the garment between a first longitudinal edge and a second longitudinal edge of the garment. The garment may include a refastenable seam that refastenably connects at least a portion of the first longitudinal edge to at least a portion of the second longitudinal edge. Additionally or alternatively, the garment may include at least one elasticized element that spans a distance between the first longitudinal edge and the second longitudinal edge when the garment is worn by the plant. The garment may include an adjustable fastening device that adjusts a width of the opening when the garment is worn by the plant.

Also according to certain embodiments, an article of clothing for a planter may include a garment configured to be fitted about at least a portion of a circumference of the planter. The garment may include an opening that extends at least a partial length of the garment between a first longitudinal edge and a second longitudinal edge of the garment. The garment may also include a refastenable seam that refastenably connects at least a portion of the first longitudinal edge to at least a portion of the second longitudinal edge. According to certain embodiments, the garment may be refastenably connected to at least a portion of the planter. Additionally or alternatively, the garment may include at least one elasticized element that spans a distance between the first longitudinal edge and the second longitudinal edge when the garment is fitted about the planter. The garment may include an adjustable fastening device that adjusts a width of the opening when the garment is fitted about the planter.

Suitable articles that may adorn the plant and/or the planter include, but are not limited to: a shirt, a diaper, pants, a dress, a skirt, a sweater, a jacket, swimwear, sleepwear, a bib, a cape, a scarf, a stole, a uniform, an apron, a bath wrap, a bathrobe, and a costume.

According to another embodiment, an ornamental adornment for a plant may include a fashion accessory and one or more supports for affixing the fashion accessory to the plant or to a planter in which the plant is planted. A first end or surface of each support may be attached to the fashion accessory while a second end or surface of each support may be configured for attachment to the plant and/or to the planter. Alternatively, a first end of each support may be attached to the fashion accessory while a second end of each support may be configured for insertion into a medium in which roots of the plant are situated. As yet another alternative, the fashion accessory may be fitted about at least a portion of a circumference of the planter.

According to yet another embodiment, the fashion accessory may form a plant hanger, which can be used to suspend the planter from a ceiling or hook, thereby keeping a bottom of the planter off of the ground or other surface. The fashion accessory may be paired with an article of clothing for the plant or planter.

Suitable fashion accessories that may adorn the plant include, but are not limited to: a necklace, earrings, a tie, eyeglasses, sunglasses, a hat, a bib, an apron, a cape, a scarf, a stole, mittens, gloves, a handbag, a backpack, a briefcase, a tote bag, a fanny pack, a belt, a holiday decoration, a musical instrument, an umbrella, a tool, facial hair, a wig, an electronic device, a dining utensil, sporting equipment, a stuffed animal, a faux food item, and faux animal body parts.

### BRIEF DESCRIPTION OF THE DRAWINGS

FIG. 1 is a front perspective view of one embodiment of an article of clothing in the form of a shirt adorning a plant.

FIG. 2 is a rear perspective view of the article of clothing in FIG. 1.

FIG. 3 is a front perspective view of another embodiment of an article of clothing in the form of a shirt adorning a planter.

FIG. 4 is a front perspective view of yet another embodiment of an article of clothing in the form of a pair of pants adorning a plant.

FIG. 5 is a rear perspective view of the article of clothing in FIG. 4.

FIG. 6 is a front perspective view of still another embodiment of articles of clothing in the form of a diaper and a bib adorning a planter and a plant.

FIG. 7 is a front perspective view of another embodiment of an article of clothing in the form of a dress adorning a plant.

FIG. 8 is a plan view of the article of clothing in FIG. 7.

FIG. 9 is a front perspective view of another embodiment of an article of clothing in the form of a dress adorning a planter.

FIG. 10 is a front perspective view of still another embodiment of articles of clothing in the form of a bikini top and a grass skirt adorning a plant and a planter.

FIG. 11 is a plan view of the articles of clothing in FIG. 10.

FIG. 12 is cross-sectional view of one embodiment of an adjustable fastening device.

FIG. 13 is a cross-sectional view of another embodiment of an adjustable fastening device.

FIG. 14a is a perspective view of one embodiment of an ornamental adornment in the form of a necklace.

FIG. 14b is a front perspective view of the ornamental adornment in FIG. 14a adorning a plant.

FIG. 15a is a perspective view of another embodiment of an ornamental adornment in the form of a necklace.

FIG. 15b is a front perspective view of the ornamental adornment in FIG. 15a adorning a planter.

FIG. 16 is a front perspective view of another embodiment of an ornamental adornment in the form of a necktie adorning a plant.

FIG. 17 is a front perspective view of another embodiment of an ornamental adornment in the form of a bowtie adorning a planter.

FIG. 18a is a perspective view of yet another embodiment of an ornamental adornment in the form of eyeglasses.

FIG. 18b is a front perspective view of the ornamental adornment in FIG. 18a adorning a plant.

FIG. 18c is a front perspective view of another embodiment of an ornamental adornment in the form of eyeglasses adorning a planter.

FIG. 19 is a front perspective view of yet another embodiment of an ornamental adornment having a refastenable holding surface and adorning a plant.

FIG. 20 is a front perspective view of one embodiment of an ornamental adornment forming a plant hanger in combination with an article of clothing adorning a planter.

### DETAILED DESCRIPTION OF THE PREFERRED EMBODIMENTS

Clothing and accessories can be configured specifically for plants and/or planters. In contrast to clothing worn by human beings, or even clothing worn by pets or dolls, clothing and accessories configured to be worn by plants are designed to be put on the plant without harming any of the plant's leaves, branches, or stems, and are also designed to be worn without adversely affecting the growth and health of the plant. Furthermore, the clothing and accessories may include an adjustable fastening system to provide an optimum fit in terms of minimizing or avoiding damage to the plant and in terms of providing a well-fitting, dapper appearance.

An article of clothing for a plant or planter suitably includes a garment 20 configured to be worn by the plant 22 or fitted about at least a portion of a circumference of the planter 24. The garment 20 may include an opening 26 that extends at least a partial length, or a full length, of the garment 20 between a first longitudinal edge 26 and a second longitudinal edge 30 of the garment 20. As used herein, the term “longitudinal edge” refers to an edge that extends a length of a garment 20 between two other edges, such as between a top edge and a bottom edge. The longitudinal edge is not limited to an edge that is parallel to a vertical axis. Furthermore, the longitudinal edges encompass a width greater than the very outermost edge of the garment 20. More particularly, the longitudinal edges include a region that may extend from the very edge of the garment to 10 cm from the edge of the garment, or from the very edge of the garment to 5 cm from the edge of the garment, or from the very edge of the garment to 2 cm from the edge of the garment, depending on the size and style of the garment 20.

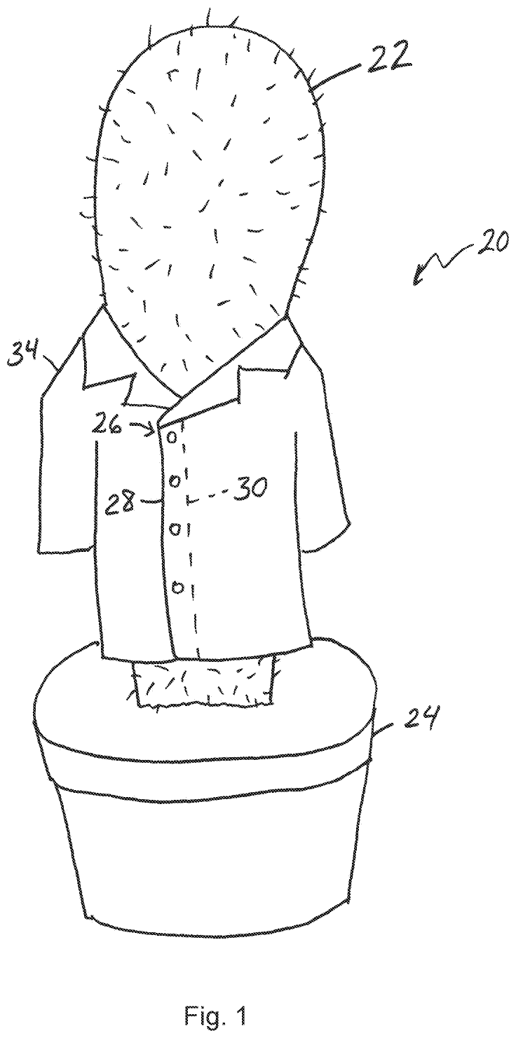

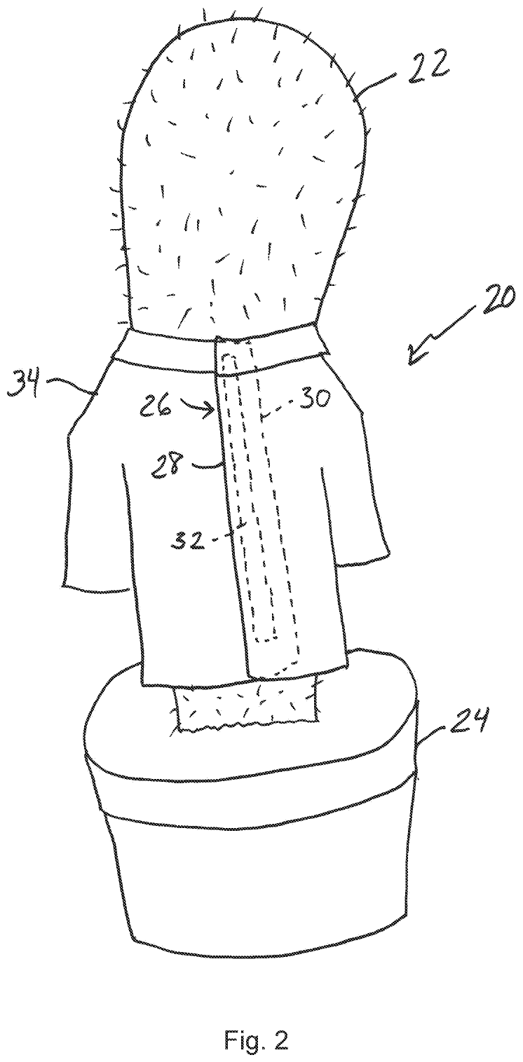

For example, FIG. 1 shows an embodiment of the garment 20 in the form of a shirt 34. The shirt 34 may include a refastenable seam 32 in the front, just like shirts worn by people. Alternatively, the front seam may be a faux seam that is not refastenable, and the refastenable seam 32 may be located in the back, as shown in FIG. 2. Thus, the shirt 34 may have a refastenable seam 32 in the front, the back, and/or on one or more sides of the shirt 34. According to certain embodiments, the garment 20 may include a refastenable seam 32 that refastenably connects at least a portion of the first longitudinal edge 38 to at least a portion of the second longitudinal edge 30 of the garment 20. In the embodiment shown in FIG. 2, the refastenable seam 32 is in the back of the shirt 34 to provide for ease of applying the garment 20 to the plant 22 or planter 24, and to provide an adjustable fit on the plant 22 or planter 24. The refastenable seam 32 may extend a full length of the shirt 34, or the seam 32 may be sewn or otherwise permanently attached along a lower portion of the seam 32 with an upper portion of the seam being refastenable, or the seam 32 may be sewn or otherwise permanently attached along the upper portion of the seam 32 with the lower portion being refastenable.

FIGS. 1 and 2 show the garment 20 in the form of a shirt 34 in place on a plant 22. The shirt 34 can be applied to the plant 22 with the refastenable seam 32 in an open position. Once the shirt 34 is in place, the refastenable seam 32 is fastened, thereby connecting at least a portion of the first longitudinal edge 28 to at least a portion of the second longitudinal edge 30. Some leaves, branches, or other portions of the plant 22 may extend through the sleeves, with a main trunk or a stem of the plant 22 extending through a body portion of the shirt 34; or the shirt 34 may be applied to the main trunk or a stem of the plant 22 with no foliage or branches extending through the sleeves. Alternatively, the shirt 34 may be applied to one or more branches or leaves without surrounding the main trunk or stem of the plant, or other branches or leaves. For example, many plants have a plethora of stems rather than a single main trunk or stem. Such plants may wear the shirt 34 on one or more stems or branches.

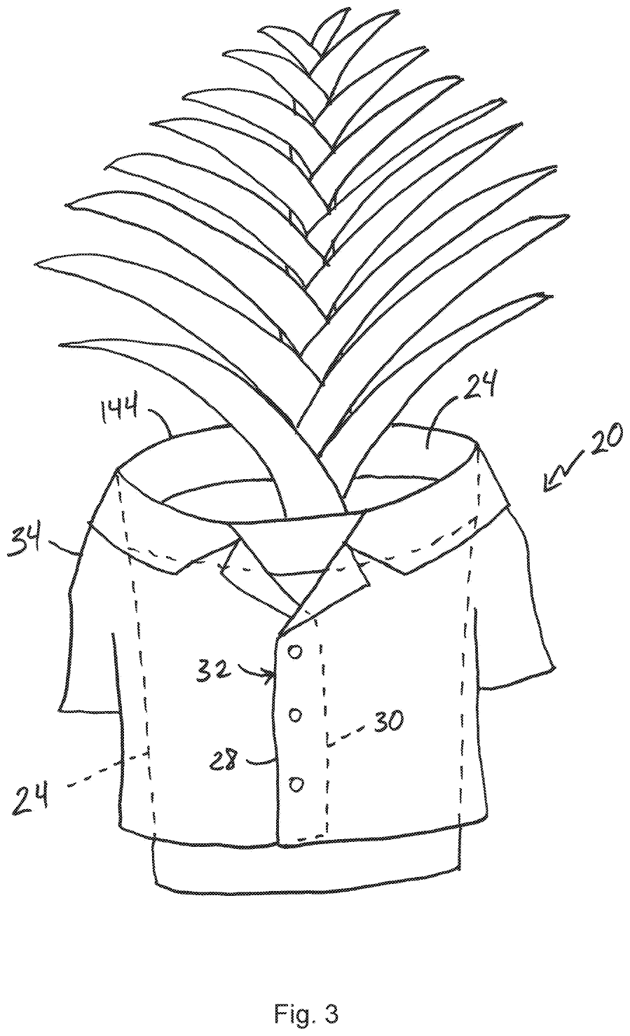

FIG. 3 shows the garment 20 in the form of a shirt 34 in place on a planter 24. The shirt 34 may be applied to the planter 24 with the refastenable seam 32 in an open position, and the refastenable seam 32 can be fastened once the shirt 34 is in place, thereby connecting at least a portion of the first longitudinal edge 28 to at least a portion of the second longitudinal edge 30. The garment 20 may be worn wholly below a top edge 144 of the planter 24, or a portion of the garment 20 may extend over the top edge 144 of the planter 24.

The garment 20 that may be applied to either the plant 22 or the planter 24 may be virtually any type of garment. Garments designed to fit plants will not necessarily fit planters, and garments designed to fit planters will not necessarily fit plants, but some garments may fit both plants and planters.

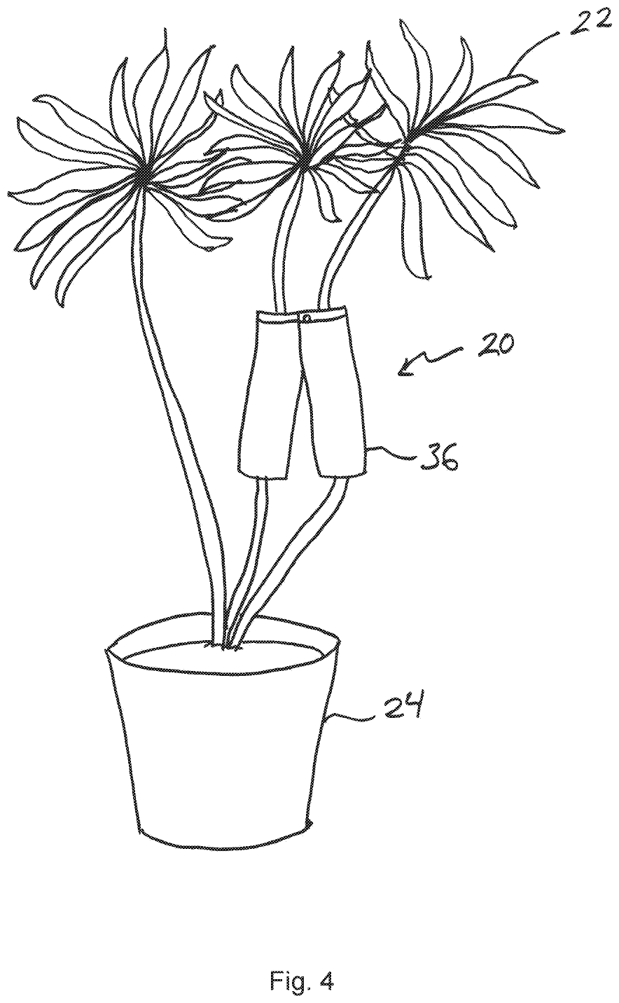

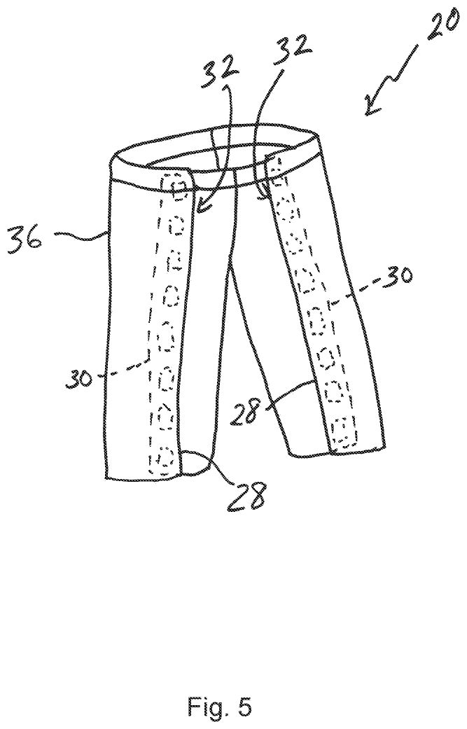

As noted above, the garment 20 may be a shirt 34, such as a button-down shirt or a t-shirt, a tank top, a sweatshirt, a sweater, or any other type of top, as shown in FIGS. 1-3. The garment 20 may also be pants, such as jeans, khaki pants, overalls, sweatpants, shorts, a skirt, or any other type of bottoms. For example, the pants 36 shown on the plant 22 in FIG. 4 have one stem of the plant 22 inserted through each pant leg. A rear view of the pants 36 in FIG. 4 is shown in FIG. 5. As can be seen in FIG. 5, each pant leg includes a refastenable seam 32 extending along a length of the pants 36 between a first longitudinal edge 28 and a second longitudinal edge 30 of the garment 20. This configuration allows the refastenable seam 32 to be opened in order to wrap the pant leg around the stems, and then the refastenable seam 32 can be fastened with refastenable fasteners, as described in detail below. Alternatively, in another embodiment (not shown), the pants could include just one refastenable seam 32 extending along a length of the pants 36 in one pant leg, such that one or more branches or stems of a plant 22 can be inserted through a single pant leg while the other pant leg hangs empty.

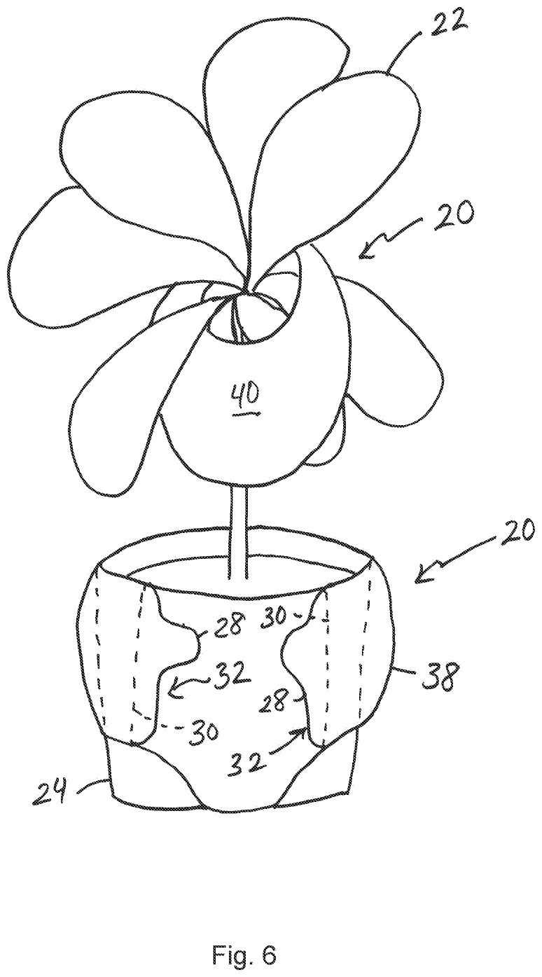

As another example, the garment 20 may also be a diaper 38, either a cloth diaper or a disposable diaper. In the same vein, the garment 40 may be a bib 40. FIG. 6 shows a bib 40 adorning a plant 22, and a diaper 38 adorning a planter 24. The bib 40 has a refastenable seam 32 extending along a length of the bib 40 between a first longitudinal edge and a second longitudinal edge of the garment 20 in the back of the bib 40 (not shown). The diaper 38 has two refastenable seams 32 extending along a length of the diaper 38 between a first longitudinal edge 28 and a second longitudinal edge 30 of the garment 20 along opposite sides of the diaper 38. Alternatively, the two longitudinal seams shown in FIG. 6 may be faux seams, while the refastenable seam 32 may be provided in the back of the diaper 38, similar to the refastenable seam 32 on the back of the shirt 34 in FIG. 2. Additionally, the diaper or other garment 20 may include an opening at the bottom that allows a flat, bottom surface of the planter 24 to protrude through the garment for added stability. However, certain embodiments of the garment 20 may cover some or all of the flat, bottom surface of the planter 24, and the garment 20 may also include at least one layer of water-resistant or waterproof material on the bottom, thereby serving as a coaster that protects a tabletop or other surface from any moisture that may seep through the planter 24.

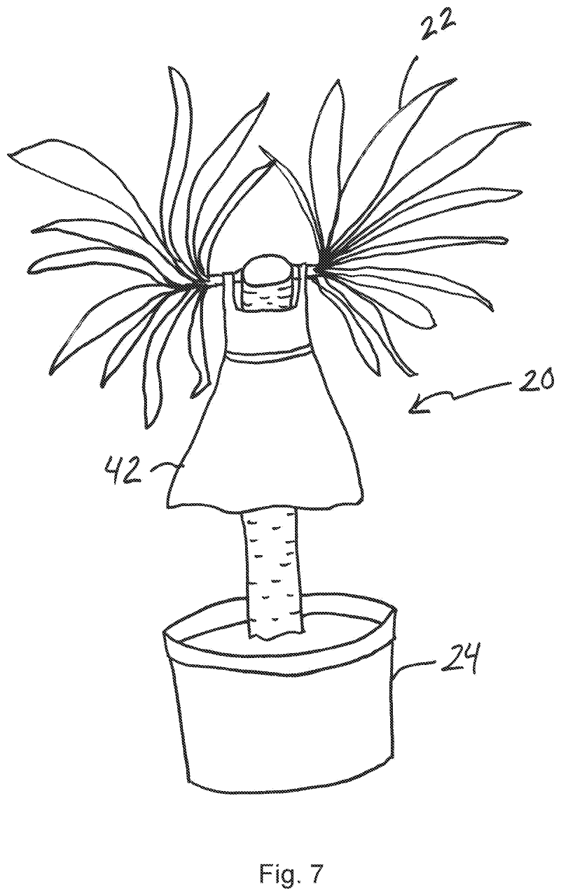

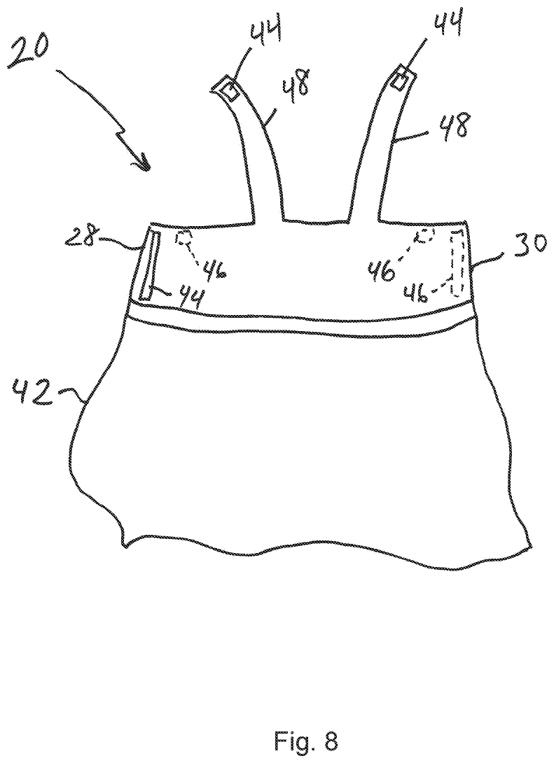

The garment 20 may also be a dress of any type, ranging from a simple sundress to an evening gown or princess gown, and any sort of dress in between. FIG. 7 shows a dress 42 adorning a plant 22. FIG. 8 shows the dress 42 in FIG. 7 in an unfastened state, with a first longitudinal edge 28 having a refastenable fastener 44 that can be attached to a corresponding fastener 46 on a second longitudinal edge 30 of the dress 42. In this embodiment, one end of each strap 48 of the dress 42 is also refastenable, enabling the straps 48 to be wrapped around branches or stems. Alternatively, each strap 48 may have a refastenable fastener 44 on each end of the strap, such that the straps 48 may be removed entirely to achieve a strapless embodiment of the dress 42. The garment 20 may also include hooks, for example, that extend from the dress 42 and can be hooked onto any portion of the plant 22.

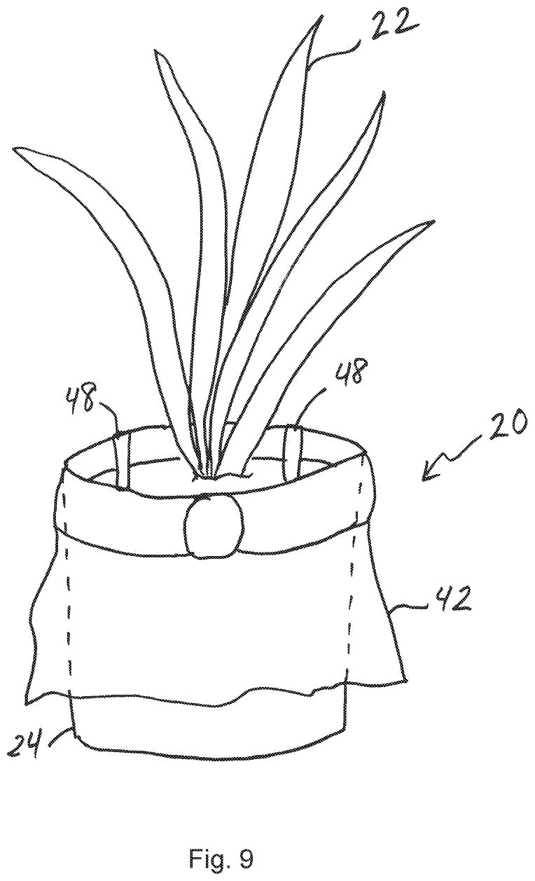

FIG. 9 shows a dress 42 adorning a planter 44. Just like the embodiment shown in FIGS. 7 and 8, the dress 42 in FIG. 9 may have a first longitudinal edge 28 having a refastenable fastener 44 that can be attached to a corresponding fastener 46 on a second longitudinal edge 30 in the back of the dress 42. According to certain embodiments, the garment 20 may be refastenably connected to at least a portion of the planter. For example, hooks may extend from the dress 42 and can be hooked onto an edge of the planter 24. As another example, refastenable materials may be located on the planter 24 and, correspondingly, on an inner surface of the garment 20. The straps 48 may be permanently attached to the dress 42, or may be refastenable on one or both ends. Additionally or alternatively, the straps 48 may be elasticized. Furthermore, the inclusion of straps 48 is optional.

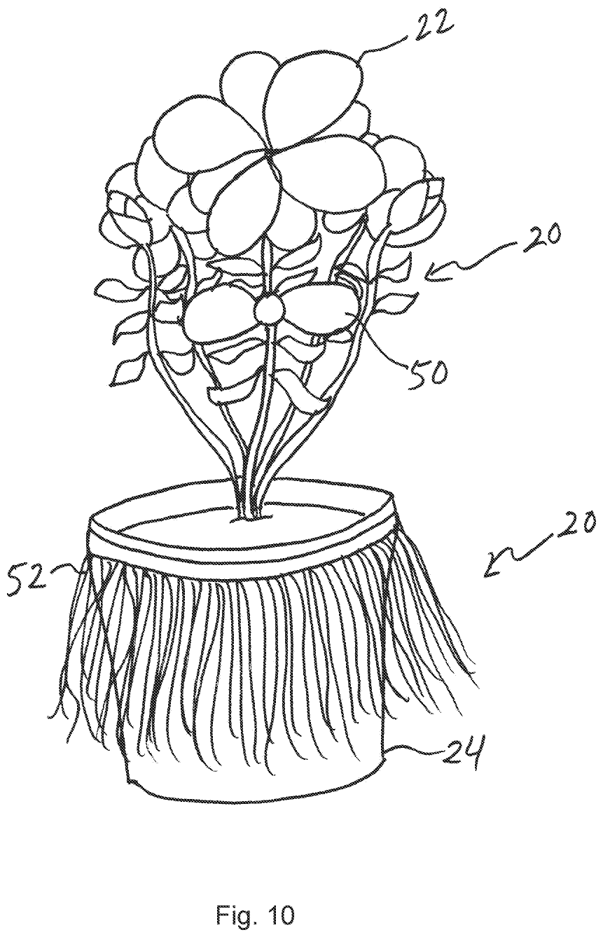

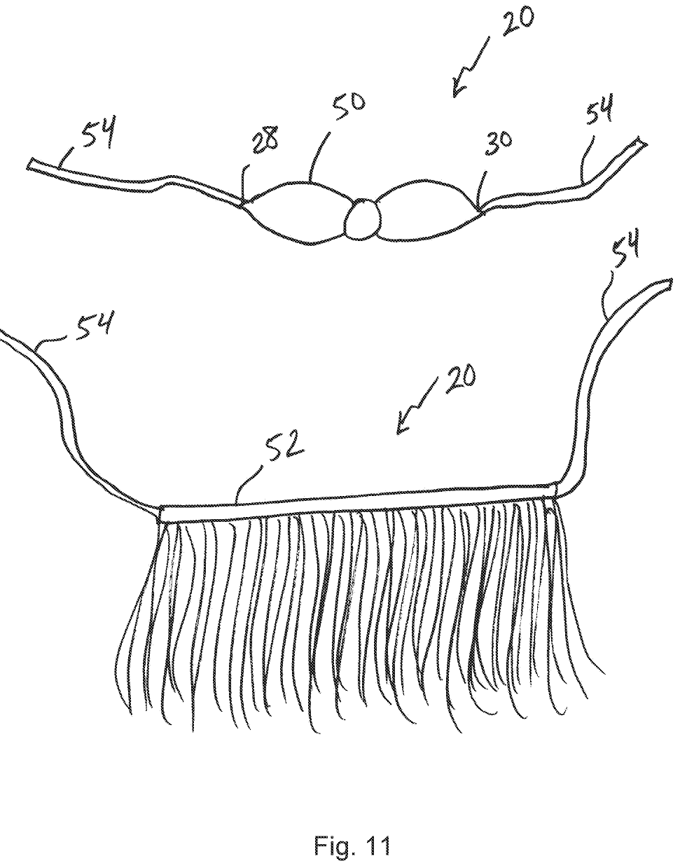

For special occasions, the garment 20 may be a costume, such as a Halloween costume, for example, a witch, a ghost, a pirate, a pumpkin, a superhero, a pop culture character, an animal, and the like. The garment 20 may also be ethnic dress garb, such as German liederhosen, a Scottish kilt, or a Hawaiian grass skirt. In certain embodiments, the garment may be swimwear and/or swim accessories, such as a swimsuit, a bikini, snorkel gear, or a beach cover-up. For example, FIG. 10 shows a bikini top 50 adorning a plant 22, and a grass skirt 52 adorning a planter 24. The bikini top 50 includes an opening that extends at least a partial length of the garment between a first longitudinal edge 28 and a second longitudinal edge 30 of the garment in the back of the bikini top 50. FIG. 11 shows the bikini top 50 in FIG. 10 in an unfastened state. The first longitudinal edge 28 and the second longitudinal edge 30 can be refastenably joined together with ties 54 or other refastenable fasteners. As exemplified by this embodiment, the first longitudinal 28 and the second longitudinal edge 30 may be spaced apart when refastenably joined together. Similarly, the grass skirt 52 includes an opening in the back that extends at least a partial length of the garment 20 between a first longitudinal edge 28 and a second longitudinal edge 30 of the garment 20. FIG. 11 also shows the grass skirt 52 in FIG. 10 in an unfastened state. Like the bikini top 50, the first longitudinal edge 28 and the second longitudinal edge 30 of the grass skirt 52 can be refastenably joined together with ties 54 or other refastenable fasteners. As another example, refastenable materials may be located on the planter 24 and, correspondingly, on an inner surface of the grass skirt 52.

The garment 20 may also be a jacket, such as a blazer, a winter jacket, a windbreaker, a jean jacket, a faux fur coat, as well as a scarf, a cape, or a stole. The garment 20 may also be sleepwear, such as pajamas or a nightgown, and may include sleep accessories, such as a sleep mask or a teddy bear. The garment 20 may also be a uniform, such as a military uniform, a scout uniform, or a work-related uniform, such as a lab coat, scrubs, a hazmat suit, or the clothing of a policeman, a fireman, a postal worker, or a dentist. The garment 20 may also be an apron, such as a bib apron or a waist apron. The garment 20 may also be a bath wrap, such as a towel-like garment that can be wrapped around one's body and fastened after bathing or showering, or a bathrobe.

The refastenable seam 32 may include hook and loop closures, such as Velcro®, snaps, buttons, magnets, a zipper, ties or laces, sticky surfaces, such as silicone or adhesives, or any other suitable refastenable device for attaching and detaching the first and second longitudinal edges 28, 30 to one another. According to certain embodiments, in addition to or in lieu of the refastenable seam 32, refastenable materials may be located on the planter 24 and, correspondingly, on an inner surface of the garment 20. For example, a hook and loop closure, such as adhesive-backed Velcro®, may be attached to at least a portion of the planter 24, such as around a circumference near a top edge of the planter, and a corresponding hook and loop closure may be attached to an inner surface of the garment 20 such that the garment 20 can be refastenably attached to the planter 24.

Additionally or alternatively, the garment 20 may include one or more elasticized elements that span a distance between the first longitudinal edge 28 and the second longitudinal edge 30 when the garment 20 is worn by the plant 22 or fitted about the planter 24. For example, the garment 20 may include two, three, or four elasticized elements that are either parallel to one another or that intersect. The elasticized elements may be strands of elastic or strands of rubber, or fabric-covered strands of elastic or rubber, for example. The garment 20 may also include elasticized portions, in the form of elastic strands or other elasticized material, for example, inserted in one or more locations of the garment 20 not necessarily between the first and second longitudinal edges 28, 30, in order to provide a more secure, adjustable fit around the plant 22 or planter 24.

In another alternative embodiment, in addition to or in lieu of the refastenable seam, the garment 20 may include hooks, such as metal or plastic hooks, that connect the garment 20 either to an edge of the planter 24 or to a part of the plant 20, such as a branch or stem. Such hooks may be bendable to enable a customized fit about the edge of the planter 24 and/or about the plant 20.

According to certain embodiments, the garment 20 may include an adjustable fastening device 56 that adjusts a width of the opening when the garment 20 is worn by the plant 22 or fitted about the planter 24. For example, one or more first fastening devices 58 may be located on or near the first longitudinal edge 28 of the garment 20, either on a surface of the garment 20 or extending from the edge of the garment 20. One or more second fastening devices 60, that can be fastened to the one or more first fastening devices 58, may be located on or near the second longitudinal edge 30 of the garment 20, either on a surface of the garment 20 or extending from the edge of the garment 20, or spanning a distance along a width of the garment 20.

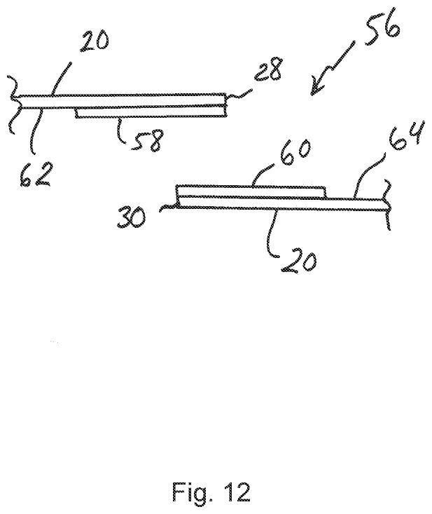

More particularly, FIG. 12 shows a cross-sectional view of one embodiment of an adjustable fastening device 56, which includes a first fastening device 58 in the form of a hook closure of a hook-and-loop fastener, located on an inner surface 62 of the garment 20 near the first longitudinal edge 28 of the garment 20, and a second fastening device 60 in the form of a loop closure of a hook-and-loop fastener, located on an outer surface 64 of the garment 20 near the second longitudinal edge 30 of the garment 20. The lengths of the individual portions of the hook and loop closures determine the range of adjustability for fitting the garment 20 around the plant 22 or planter 24.

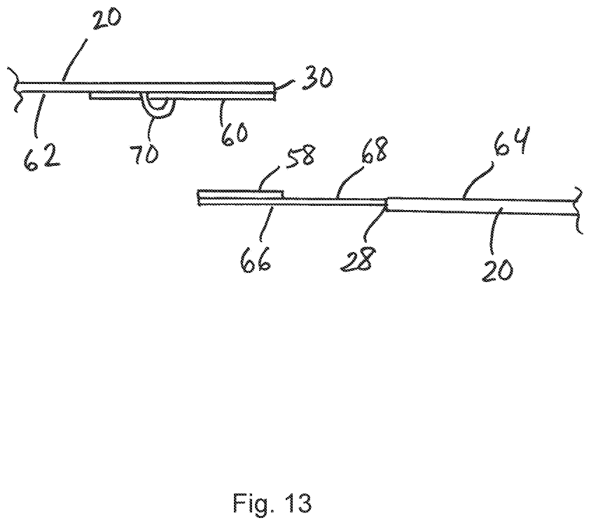

FIG. 13 shows a cross-sectional view of another embodiment of an adjustable fastening device 56, which includes a first fastening device 58 in the form of a hook closure of a hook-and-loop fastener, located on an outer surface 68 of a strand of elastic 66, with the strand of elastic 66 attached on or near the first longitudinal edge 28 of the garment 20. A second fastening device 60 in the form of a loop closure of a hook-and-loop fastener is located on an inner surface 62 of the garment 20 near the second longitudinal edge 30 of the garment 20. The garment 20 may also include one or more support loops 70, formed of fabric, plastic, elastic, or other suitable materials, through which the elastic strand 66 with the hook closure may be threaded prior to attaching the hook closure to the loop closure. Additionally, the strand of elastic 66 may have an adjustable length, such as through the inclusion of a ring piece and a slider piece, with the strand of elastic 66 woven through the slider and ring. Alternatively, a non-elasticized strap of material may be used in place of the strand of elastic 66, and the non-elasticized strap may have an adjustable length, such as through the inclusion of a ring piece and a slider piece, with the non-elasticized strap woven through the slider and ring.

In each of the embodiments described herein, the hook closure and the loop closure may be interchanged, switching locations as one sees fit.

According to another aspect of the invention, an ornamental adornment for a plant or planter may include a fashion accessory 120 for adorning a plant 22 or a planter 24. The ornamental adornment may also include one or more supports 122 for affixing the fashion accessory 120 to the plant 22 or to a planter 24 in which the plant 22 is planted. The supports 122 may be made of plastic, wood, metal, fabric, or any other suitable material. For example, the supports 122 may be between about 1 cm and about 1 meter long, or between about 5 cm and about 50 cm, or between about 5 cm and about 25 cm long. The supports 122 may be stick-like supports 123, such as in the form of a chopstick, baton, or sewing needle, for example. Alternatively, the support or supports 122 may be in the form of a clip support 124, such as in the form of a hairpin, barrette, or other clip. Such clips 124 may have extra lining, for example a felt or other soft lining, to protect the leaves of the plant 22 from any damaging force. Examples of other suitable lining materials include cotton, velvet, suede, and any other fluffy or puffy materials. The supports 122 may be in the form of hooks, such as metal or plastic hooks, that connect the fashion accessory 120 either to an edge of the planter 24 or to a part of the plant 20, such as a branch or stem. Such hooks may be bendable to enable a customized fit about the edge of the planter 24 and/or about the plant 20. For example, the hooks may be wire, coated wire, or wired-ribbon that can be wrapped one or more times around one or more branches, stems, or leaves, to secure the fashion accessory 120 to the plant 20. Alternatively, the fashion accessory 120 may be applied to the plant 22 or planter 24 in any of the same manners as described above with respect to the article of clothing 20. More particularly, the fashion accessory 120 may include an opening 126 that extends at least a partial length of the fashion accessory 120 between a first longitudinal edge 128 and a second longitudinal edge 130 of the fashion accessory 120, and the fashion accessory 120 may include a refastenable seam 132 that refastenably connects at least a portion of the first longitudinal edge 128 to at least a portion of the second longitudinal edge 130. The fashion accessory 120 may also include one or more elasticized elements and/or adjustable straps, as described herein.

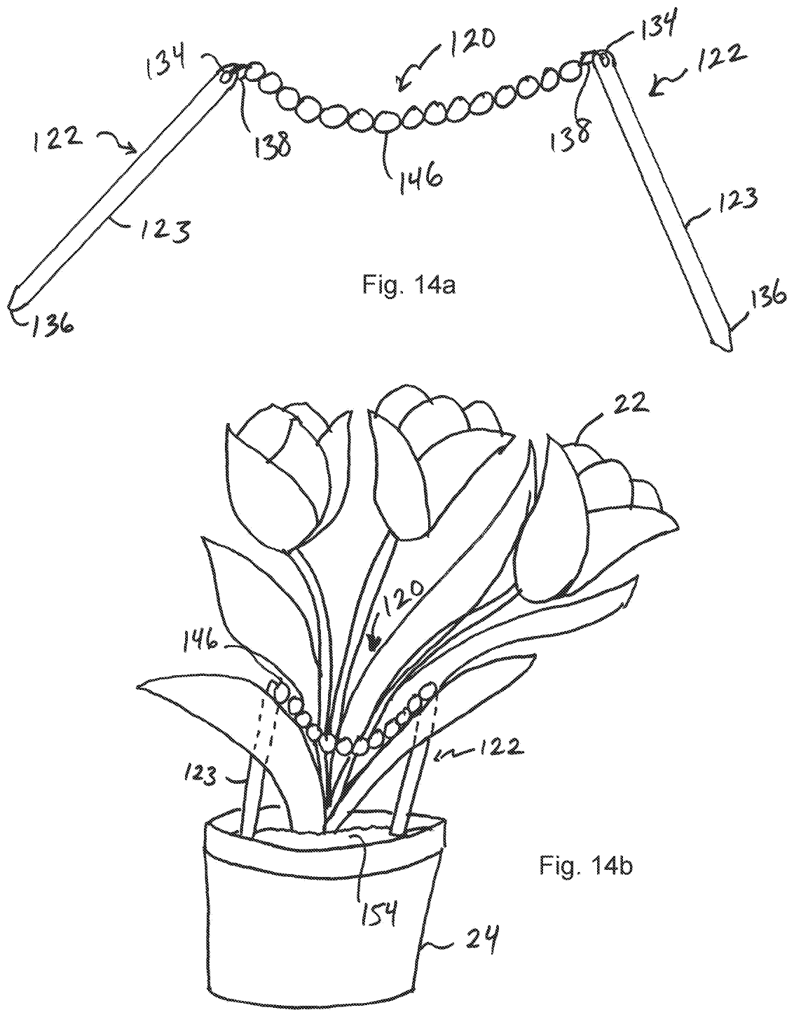

According to certain embodiments, particularly with a stick-like support 123 as illustrated in FIGS. 14a and 14b, one end 134 of the support 123 may be attached to the fashion accessory 120, such as a necklace 146, and an opposite end 136 of the support 123 may be configured for insertion into a medium 154 in which roots of the plant 22 are situated, such as soil, rocks, or other planting media. The end 134 of the support 123 attached to the fashion accessory 120 may be fixedly or permanently attached to the fashion accessory 120; or the end 134 of the support 123 attached to the fashion accessory 120 may be refastenably attached to the fashion accessory 120, such as with strings or ties or hook-and-loop fasteners, for example. Additionally, an end 138 of the fashion accessory 120 attached to the end 134 of the support 123 may have an adjustable length, such as through the inclusion of a ring piece and a slider piece, with a length of the end of the fashion accessory 120 woven through the slider and ring.

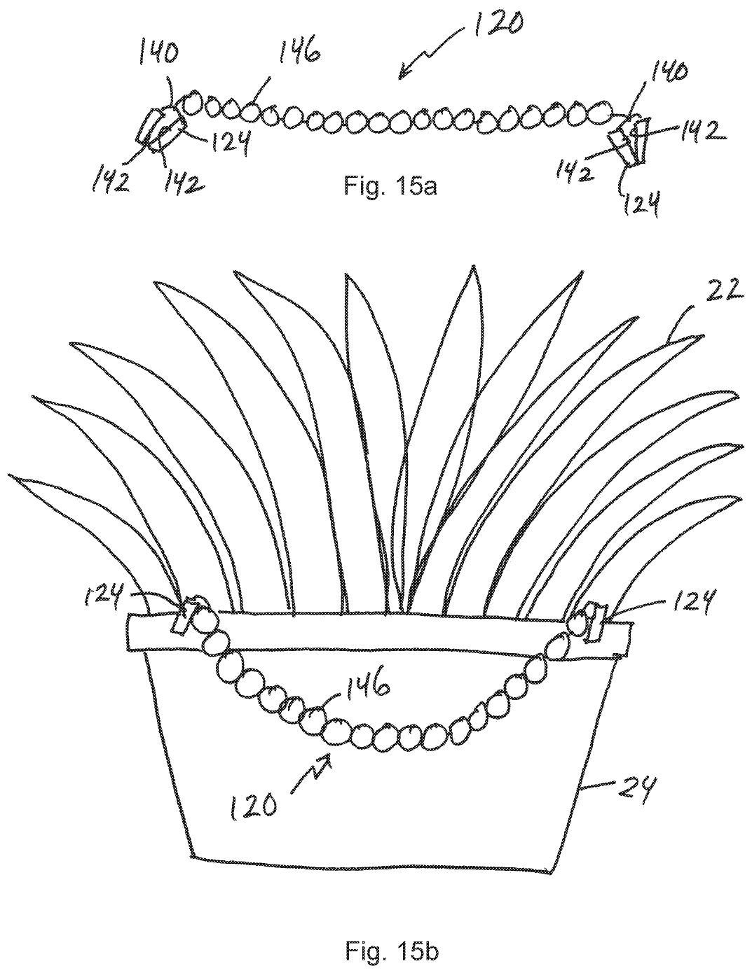

According to certain embodiments, particularly with one or more supports 122 in the form of a clip 124 as illustrated in FIGS. 15a and 15b, the fashion accessory 120, in this case a necklace 146, may be attached to the planter 24, with the clip 124 support attached to the edge or rim 144 of the planter 24, for example. Alternatively, the fashion accessory 120 may be attached to an outer surface 140 of the clip support 124, and the clip support 124 may be attached to the plant 22 by inserting a leaf or other portion of the plant 22 between two surfaces 144 of the clip support 124. The outer surface 140 of the clip support 124 attached to the fashion accessory 120 may include any of the refastenable materials and devices described above, such as strings or ties or hook-and-loop fasteners, for example. Alternatively, the outer surface 140 of the clip support 124 attached to the fashion accessory 120 may be fixedly or permanently attached to the fashion accessory 120, such as with adhesive, welding, or mechanical fastening, such as tied with plastic, metal, or fabric fasteners.

According to still other embodiments, the fashion accessory 120 may be configured to be fitted about at least a portion of a circumference of the planter 24. The fashion accessory 120 may be attached to the planter 24 either permanently, such as with adhesive, welding, or mechanical fastening, such as tied with plastic, metal, or fabric fasteners; or the fashion accessory 120 may be refastenably attached to the planter 24 or to a corresponding surface of the fashion accessory 120 itself, such as with any of the refastenable materials and devices described above.

The fashion accessory 120 that may be applied to either the plant 22 or the planter 24, or to a plant hanger, may be virtually any type of fashion accessory. For example, the fashion accessory 120 may be jewelry, such as the necklace 146 shown in FIGS. 14a, 14b, 15a, and 15b. Alternatively, jewelry may include a brooch, a ring, an ear cuff, a tiara, earrings, or any other suitable type of jewelry.

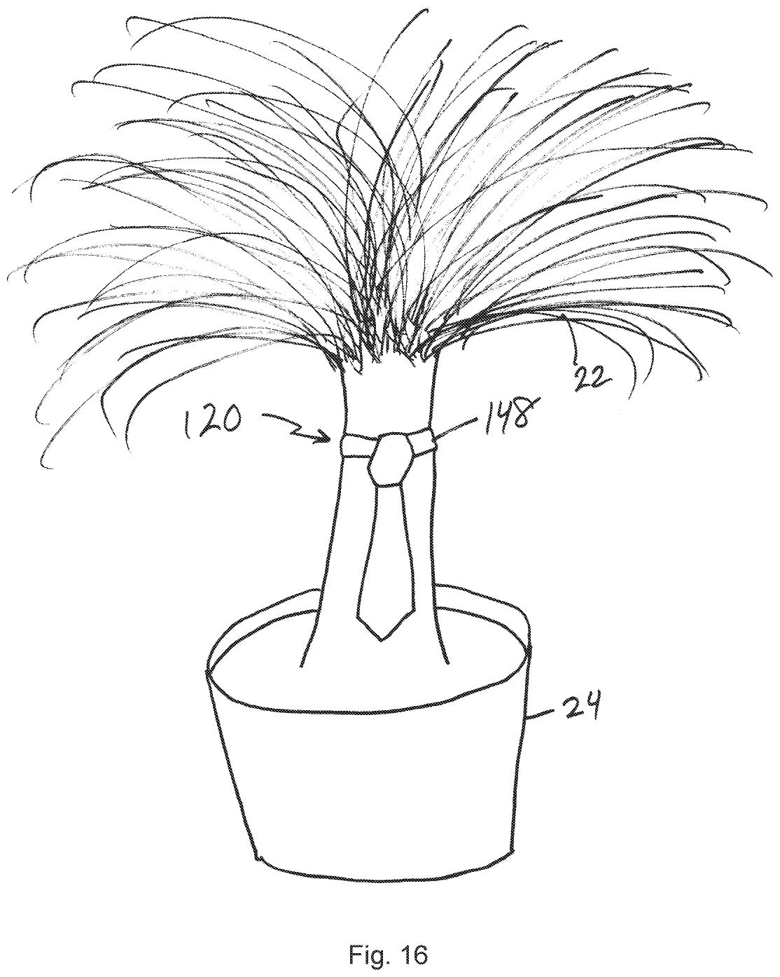

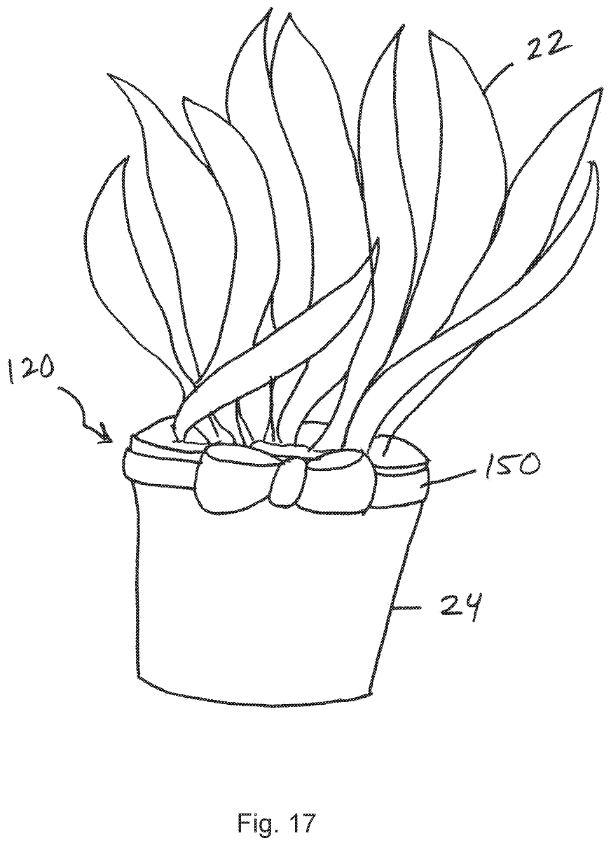

As another example, the fashion accessory 120 may be a tie, such as either a necktie 148 or a bowtie 150, as shown in FIGS. 16 and 17. The necktie 148 and bowtie 150 shown in FIGS. 16 and 17 can be attached to the plant 22 and planter 24, respectively, using an adjustable fastening device 56, such as those illustrated in FIGS. 12 and 13, for example. The adjustable fastening device 56 applied to the fashion accessory 120 may also include one or more elasticized elements and/or adjustable straps, as described herein.

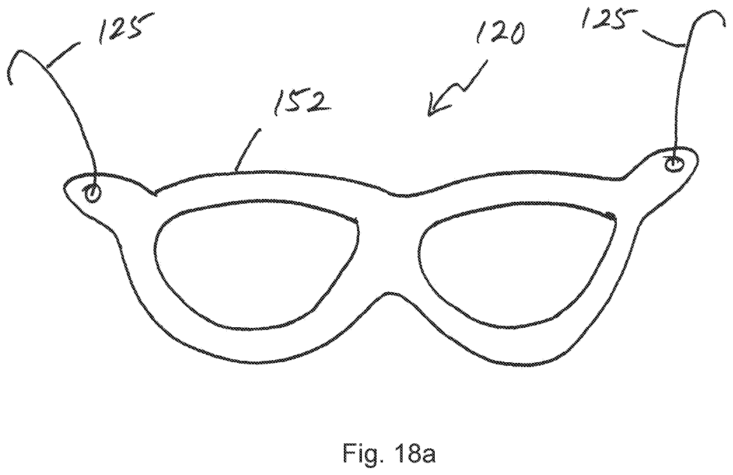

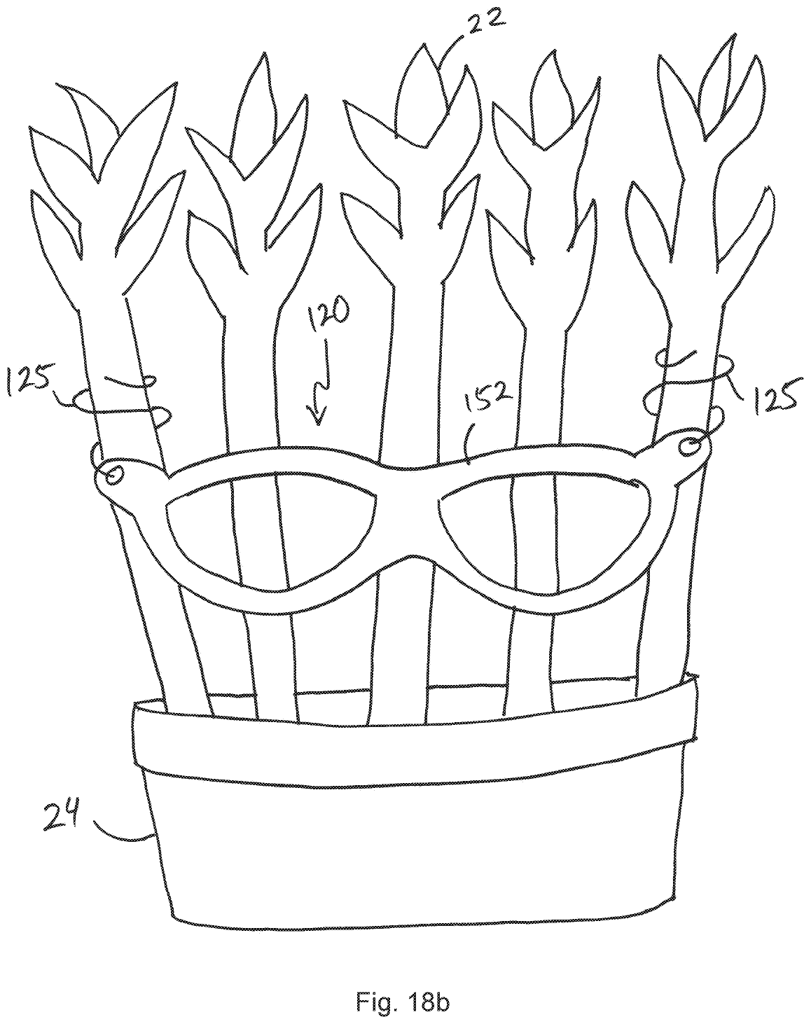

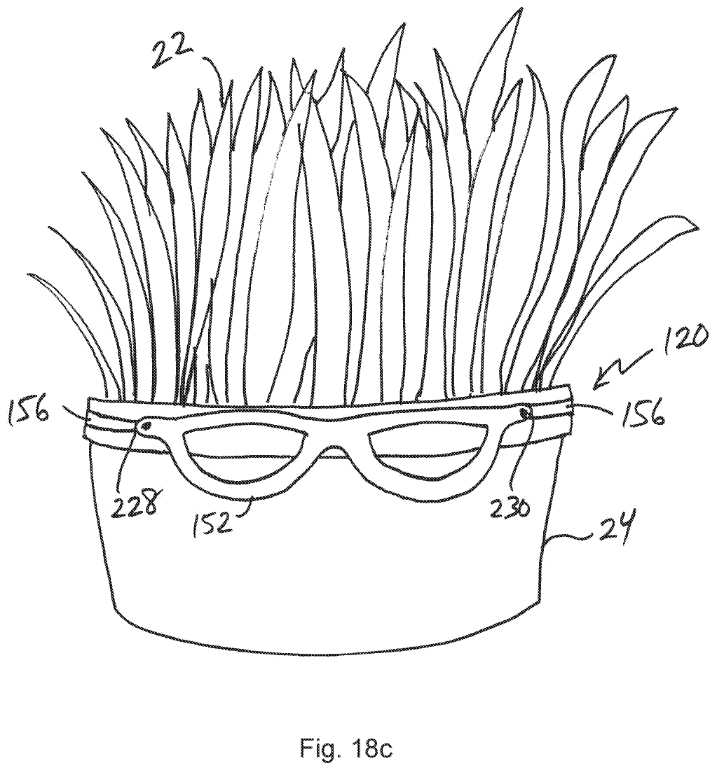

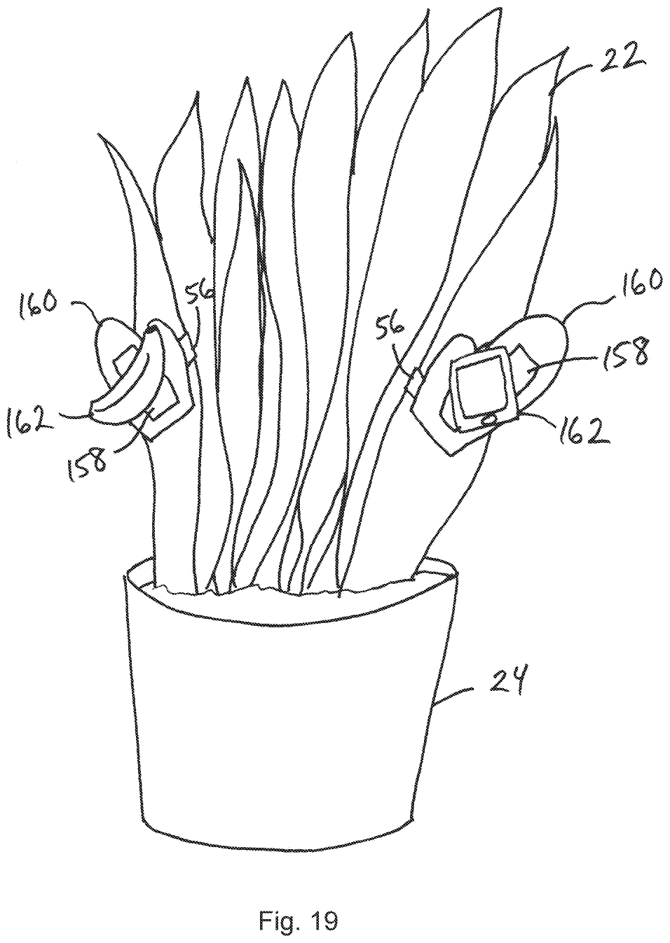

The fashion accessory 120 may also be eyeglasses 152, such as vision eyeglasses, fashion eyeglasses, or sunglasses, as shown in FIGS. 18a, 18b, and 18c. The eyeglasses 152 may include hooks 125, as shown in FIG. 18a. One end of each hook 125 may be attached to the eyeglasses 152 and an opposite end of each hook 125 can be wrapped around or latched onto a part of the plant 20, as shown in FIG. 18b. Alternatively, the fashion accessory 120 may include one or more elasticized elements 156 that span a distance between a first longitudinal edge 228 of the eyeglasses 152 and a second longitudinal edge 230 of the eyeglasses 152 when the fashion accessory 120 is either worn by a plant 22 or when fitted about the planter 24, as shown in FIG. 18c. The elasticized elements 156 may be strands of elastic or strands of rubber, or fabric-covered strands of elastic or rubber, for example.

Other suitable fashion accessories 120 that can adorn plants 22 and/or planters 24, as described herein, include: a hat, such as a bowler, derby, top hat, winter cap, chef's toque, or a shower cap; a bow; earmuffs, earbuds, or headphones; a bib; an apron; a cape; a mask or sleep mask; a scarf; a stole; shoes or other footwear; mittens; gloves; artificial body parts, such as hands, feet, or a nose; a book; a handbag; a backpack; a briefcase; a tote bag; a fanny pack; a belt or collar; a holiday decoration, such as Christmas, Easter, Valentine's Day, Halloween, Fourth of July, Mardi Gras, St. Patrick's Day, New Year's, or Thanksgiving decorations; a musical instrument, such as a viola, cello, violin, guitar, banjo, bagpipes, trumpet, trombone, clarinet, saxophone, flute, or accordion; an umbrella; a tool, such as a hammer, wrench, screwdriver, or drill; facial hair, such as a faux fur beard and/or mustache; a wig or other hair piece, alone and/or with hair accessories, such as a brush, a bow, barrettes, scrunchies; an electronic device, such as a cellphone or a laptop; a disco ball; a dining utensil, such as a fork, spoon, knife, or mug; sporting equipment, such as a ball, racket, surfboard, skis, bat, or helmet; other hobby equipment, such as art or sewing supplies; a stuffed animal; a faux food or drink item, such as a burger, taco, banana, soda bottle, or wine bottle; ethnic dress garb, such as a French beret, a Viking horned helmet, a Scottish kilt, or a Hawaiian lei; or a faux animal body part, such as an animal tail, wings, a snout, animal ears, animal horn, or an animal trunk.

Certain fashion accessories 120 that include storage spaces, such as a handbag, a backpack, a briefcase, a tote bag, or a fanny pack, can be used to store plant accessories, such as plant food or fertilizer; or to house music playing devices, such as a radio or speaker or other sound maker; or to house fragrance, such as an air freshener; or to house one or more lights.

Certain fashion accessories 120 may include refastenable holding surfaces 158. For example, fashion accessories 120 such as mittens, gloves, or artificial hands, or even a generic, non-specifically shaped, holding surface, may be affixed to a plant 22 or planter 24 and provided with a hook or loop fastener surface, or other refastenable surface that can be used to hold decorative or utilitarian features that are affixed with a corresponding loop or hook fastener or other refastenable fastening device. For example, any of the fashion accessories 120 listed above may be refastenably attached to the refastenable holding surface 158. When desired, the fashion accessory 120 may be swapped out for a different fashion accessory 120. The refastenable holding surfaces 158 are not limited to hook-and-loop fasteners, but may also include sticky surfaces such as silicone or adhesive-covered surfaces, surfaces that adhere to one another through enhanced friction, magnets, snaps, buttons, ties or laces, or any other suitable refastenable device for attaching and detaching the decorative or utilitarian features to the holding surfaces 158. For example, as shown in FIG. 19, a first accessory 160 in the form of a mitten may be affixed to a plant 22, such as with an adjustable fastening device 56 as illustrated in FIGS. 12 and 13. A second accessory 162, such as a banana or a cellphone, may be refastenably attached to the first accessory 160. When it is desired to replace the banana or cellphone with another accessory, the cellphone may be removed and easily replaced with a different second accessory 162.

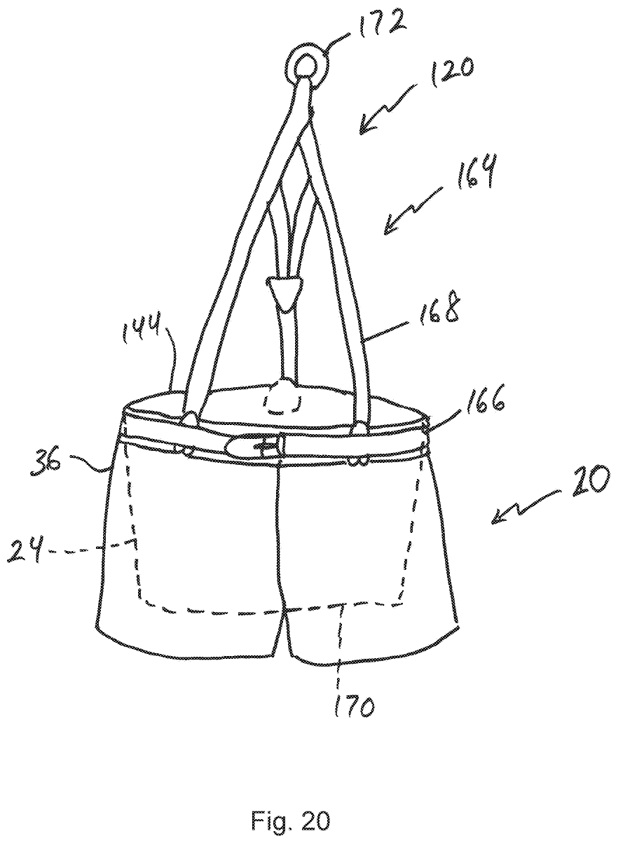

The fashion accessory 120 may also form a plant hanger 164, which can be used to suspend the planter 24 from a ceiling or hook, thereby keeping a bottom 170 of the planter 24 off of the ground or other surface. The fashion accessory 120 may be paired with a garment 20 for the plant 22 or planter 24. For example, as shown in FIG. 20, the fashion accessory 120 may be a belt 166 and/or suspenders 168 forming a plant hanger 164, paired with a garment 20 in the form of a pair of pants of shorts 36. When the fashion accessory 120 forms a plant hanger 164, the fashion accessory 120 suitably extends below at least a top edge 144 of the planter 24, and/or below a bottom surface 170 of the planter 24, and can be removably connected to the planter 24, either through a mechanical fit with the planter 24 or through a refastenable connection, such as with any of the refastenable materials and devices described above. The plant hanger 164 may also include a loop 172 or other support structure for attaching the plant hanger 164 to a corresponding hook.

The clothing and/or accessories described herein may also be paired with matching clothing and/or accessories to be worn by humans and/or by pets, such as dogs or cats.

While the clothing and accessories described herein are designed to avoid harming the plant's health and growth, the clothing and accessories are not limited to use on living houseplants. The clothing and accessories may be applied to either living plants or artificial plants, such as silk or plastic plants. According to certain embodiments, the clothing and/or accessories may be formed of translucent or transparent material, to allow natural light to pass through the clothing and/or accessories. Furthermore, the clothing and accessories may be applied to either indoor plants or outdoor plants. The plants to which the clothing and accessories may be applied can either be potted plants or plants rooted into the ground. Examples of suitable types of plants to which the clothing and accessories may be applied include houseplants, such as palm plants, ferns, philodendrons, orchids, money tree plants, fiddle leaf figs, snake plants, spider plants, hoya heart plants, monstera, schefflera, calathea, air plants, cacti and other succulents, birds of paradise, bonsai, lucky bamboo, aloe vera, ZZ plants, olive trees, lime trees, lemon trees, orange trees; herb plants, such as rosemary plants, oregano, thyme, lavender, basil, parsley; flowering plants, such as lilies, tulips, daffodils, paperwhites, crocuses, roses, amaryllis, daisies, hydrangeas, irises; and various other plants that can be grown indoors or outdoors.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An article of clothing for a plant, comprising:
a garment configured to be worn by the plant, wherein the garment includes an opening that extends at least a partial length of the garment between a first longitudinal edge and a second longitudinal edge of the garment.

2. The article of claim 1, wherein the garment comprises a refastenable seam that refastenably connects at least a portion of the first longitudinal edge to at least a portion of the second longitudinal edge.

3. The article of claim 1, wherein the garment comprises at least one elasticized element that spans a distance between the first longitudinal edge and the second longitudinal edge when the garment is worn by the plant.

4. The article of claim 1, wherein the garment comprises an adjustable fastening device that adjusts a width of the opening when the garment is worn by the plant.

5. The article of claim 1, wherein the garment is selected from the group consisting of: a shirt, pants, a dress, a skirt, a sweater, a jacket, swimwear, sleepwear, a bib, a cape, a scarf, a stole, a uniform, an apron, a bath wrap, a bathrobe, and a costume.

6. An article of clothing for a planter, comprising:
a garment configured to be fitted about at least a portion of a circumference of the planter.

7. The article of claim 6, wherein the garment includes an opening that extends at least a partial length of the garment between a first longitudinal edge and a second longitudinal edge of the garment.

8. The article of claim 7, wherein the garment comprises a refastenable seam that refastenably connects at least a portion of the first longitudinal edge to at least a portion of the second longitudinal edge.

9. The article of claim 7, wherein the garment comprises at least one elasticized element that spans a distance between the first longitudinal edge and the second longitudinal edge when the garment is fitted about the planter.

10. The article of claim 7, wherein the garment comprises an adjustable fastening device that adjusts a width of the opening when the garment is fitted about the planter.

11. The article of claim 6, wherein the garment comprises a refastenable material on an inner surface of the garment and the planter comprises a refastenable material on a surface of the planter, and the refastenable materials enable the garment to be refastenably attached to the planter.

12. The article of claim 6, wherein the garment is selected from the group consisting of: a shirt, a diaper, pants, a dress, a skirt, a sweater, a jacket, swimwear, sleepwear, a bib, a cape, a scarf, a stole, a uniform, an apron, a bath wrap, a bathrobe, and a costume.

13. An ornamental adornment for a plant, comprising:
a fashion accessory; and
at least one support for affixing the fashion accessory to the plant or a planter in which the plant is planted.

14. The ornamental adornment of claim 13, wherein a first end of the at least one support is attached to the fashion accessory and a second end of the at least one support is configured for attachment to the plant or planter.

15. The ornamental adornment of claim 14, wherein the second end of the at least one support comprises a refastenable attachment element for attaching the at least one support to the plant or planter.

16. The ornamental adornment of claim 13, wherein a first end of the at least one support is attached to the fashion accessory and a second end of the at least one support is configured for insertion into a medium in which roots of the plant are situated.

17. The ornamental adornment of claim 16, wherein the first end of the at least one support comprises a refastenable attachment element for attaching the at least one support to the fashion accessory.

18. The ornamental adornment of claim 13, wherein the fashion accessory is configured to be fitted about at least a portion of a circumference of the planter.

19. The ornamental adornment of claim 13, wherein the fashion accessory is selected from the group consisting of: a necklace, a tie, eyeglasses, sunglasses, a hat, a bib, an apron, a cape, a scarf, a stole, mittens, gloves, a handbag, a backpack, a briefcase, a tote bag, a fanny pack, a belt, a holiday decoration, a musical instrument, an umbrella, a tool, facial hair, a wig, an electronic device, a dining utensil, sporting equipment, a stuffed animal, a faux food item, and faux animal body parts.

20. The ornamental adornment of claim 13, wherein the fashion accessory includes an opening that extends at least a partial length of the fashion accessory between a first longitudinal edge and a second longitudinal edge of the fashion accessory.
